(19) United States
(12) Patent Application Publication
(10) Pub. No.: US 2024/0235737 A1
(43) Pub. Date: Jul. 11, 2024

(54) TRANSMITTER FOR IMPROVING CG PUSCH REPETITION IN MULTI-TRP SCENARIO

(71) Applicant: TCL COMMUNICATION (NINGBO) CO., LTD., Ningbo, Zhejiang (CN)

(72) Inventors: Tian LI, Ningbo, Zhejiang (CN); Jia SHENG, Ningbo, Zhejiang (CN)

(73) Assignee: TCL COMMUNICATION (NINGBO) CO., LTD., Ningbo, Zhejiang (CN)

(21) Appl. No.: 18/558,746

(22) PCT Filed: May 7, 2021
(86) PCT No.: PCT/CN2021/092072

§ 371 Date: Nov. 3, 2023

(51) Int. Cl. H04L 1/08; H04L 5/00; H04W 72/1268; H04W 72/232

(52) U.S. Cl. CPC H04L 1/08; H04L 5/0035; H04W 72/1268; H04W 72/232

(57) ABSTRACT

Disclosed is a transmitter for improving CG PUSCH repetition in multiple transmission-reception point (multi-TRP)/panel scenario. Several solutions are proposed to support multi-TRP based CG PUSCH repetition, which include a development on indication of single-TRP/multi-TRP based CG PUSCH repetition, beam mapping, RV sequences and initial transmission occasions. Taking these solutions into consideration, the support for CG PUSCH repetition in multi-TRP/panel scenario is greatly enhanced.

### TECHNICAL FIELD

The present disclosure relates to the field of wireless communication systems, and more particularly, to a transmitter for improving configured grant (CG) physical uplink shared channel (PUSCH) repetition in multiple transmission-reception point (multi-TRP)/panel scenario.

### BACKGROUND ART

Wireless communication systems, such as the third-generation (3G) of mobile telephone standards and technology are well known. Such 3G standards and technology have been developed by the Third Generation Partnership Project (3GPP). The 3rd generation of wireless communications has generally been developed to support macro-cell mobile phone communications. Communication systems and networks have developed towards being a broadband and mobile system. In cellular wireless communication systems, user equipment (UE) is connected by a wireless link to a radio access network (RAN). The RAN includes a set of base stations (BSs) which provide wireless links to the UEs located in cells covered by the base station, and an interface to a core network (CN) which provides overall network control. The RAN and CN each conducts respective functions in relation to the overall network. The 3rd Generation Partnership Project has developed the so-called Long Term Evolution (LTE) system, namely, an Evolved Universal Mobile Telecommunication System Territorial Radio Access Network, (E-UTRAN), for a mobile access network where one or more macro-cells are supported by a base station known as an eNodeB or eNB (evolved NodeB). More recently, LTE is evolving further towards the so-called 5G or NR (new radio) systems where one or more cells are supported by a base station known as a next generation Node B called gNodeB (gNB).

The 5G standard will support a multitude of different services each with very different requirements. These services include Enhanced Mobile Broadband (eMBB) for high data rate transmission, Ultra-Reliable Low Latency Communication (URLLC) for devices requiring low latency and high link reliability and Massive Machine-Type Communication (mMTC) to support a large number of low-power devices for a long life-time requiring highly energy efficient communication.

A base station (BS) refers to a network central unit in the NR that is used to control one or multiple TRPs associated with one or multiple cells. A BS could be referred to as, eNB, NodeB, or gNodeB (also called gNB). A TRP is a transmission and reception point that provides network coverage and directly communicates with UEs, for example. A cell is composed of one or multiple associated TRPs, i.e. the coverage of the cell is a superset of the coverage of all the individual TRP(s) associated with the cell. One cell is controlled by one BS. A cell can also be referred to as a TRP group (TRPG).

To exploit multiple path propagation, MIMO is a method for multiplying the capacity of a radio link using multiple transmission and receiving antennas. By deploying multiple antennas at the transmitter and the receiver, MIMO refers to a practical technique for sending and receiving more than one data signal simultaneously over the same radio channel, which improves the performance of spectral efficiency greatly.

As shown in FIG. 1, for a UE operating in multi-TRP/panel transmission in NR, PUSCH repetition can be scheduled in different transmission occasions toward different TRPs so that UE has multiple chances to perform PUSCH transmission. PUSCH repetition targeting towards different TRPs can avoid possible blockage between any TRP and the UE. As a result, PUSCH repetition not only enhance the reliability but also improve the coverage.

Regarding the deployment of multi-TRP/panel, single-DCI based multi-TRP PUSCH repetition and multiple-DCI based multi-TRP PUSCH repetition are developed. Single-DCI based multi-TRP PUSCH repetition is beneficial when different TRPs are connected by ideal backhaul, while multi-TRP PUSCH repetition is beneficial when different TRPs are connected by non-ideal backhaul.

PUSCH transmission can be dynamically scheduled by an UL grant in a DCI, or the transmission can correspond to a configured grant type 1 or type 2. The configured grant type 1 PUSCH transmission is semi-statically configured to operate upon the reception of higher layer parameter of configured grant configuration (e.g. ConfiguredGrantConfig) including configured UL grant parameter (e.g. rrc-ConfiguredUplinkGrant) without the detection of an UL grant in a DCI. The configured grant type 2 PUSCH transmission is semi-persistently scheduled by an UL grant in a valid activation DCI after the reception of higher layer parameter of configured grant configuration (e.g. ConfiguredGrantConfig) not including configured UL grant parameter (e.g. rrc-ConfiguredUplinkGrant). More than one configured grant configuration of configured grant type 1 and/or configured grant type 2 can be active at the same time in an active bandwidth part (BWP) of a serving cell.

In Rel-15/16, PUSCH repetition type A and type B have been specified. For PUSCH repetition type A, different repetitions of PUSCH are in different slots, which have the same length and starting symbol. For PUSCH repetition type B, due to the crossing slot boundary or invalid symbols, a nominal repetition is divided into multiple actual repetitions. For PUSCH repetition type A, the number of repetitions is determined by the higher layer parameter numberOfRepetitions-r16 and pusch-AggregationFactor. For PUSCH repetition type B, the number of nominal repetitions is determined by the higher layer parameter numberOfRepetitions-r16. Regarding single-DCI based multi-TRP PUSCH repetition type A and type B, a single DCI schedules all the PUSCH repetitions.

### RELATED ARTS

In RAN1 #104e meeting, two sounding reference signal (SRS) resource indicator (SRI) fields corresponding to two sounding reference signal (SRS) resource sets are supported and the detailed agreement is shown as follows:

### Agreement:

For single DCI based M-TRP PUSCH repetition schemes, in codebook based PUSCH,
Support two SRI fields corresponding to two SRS resource sets are included in DCI formats 0_1/0_2.
   Each SRI field indicating SRI per TRP, where the SRI field based on Rel-15/16 framework
Support dynamic switching between multi-TRP and single-TRP operation
FFS: Support dynamic switching the order of two TRPs

In RAN1 #104e meeting, single CG configuration based CG PUSCH transmission towards M-TRPs is supported and TRP specific procedure is proposed to be further studied. The detailed agreement is shown as follows:

### Agreement:

Support CG PUSCH transmission towards M-TRPs using a single CG configuration.
Use same beam mapping principals as dynamic grant PUSCH repetition scheme.
FFS: Required changes on CG parameters (ConfiguredGrantConfig)
The feature is UE optional

### Technical Problem

CG PUSCH repetition in multiple transmission-reception point(multi-TRP)/panel scenario is needed to be improved in this field.

### Technical Solution

A first aspect of the present disclosure provides a transmitter, configured to communicate in a communication system, the transmitter including: one or more interfaces configured to communicate with multiple transmission-reception points (multi-TRPs) within the communication system; and a circuitry configured to: receive or transmit an indication of a support of single-TRP based configured grant (CG) physical uplink shared channel (PUSCH) repetition or multi-TRP based CG PUSCH repetition.

A second aspect of the present disclosure provides a transmitter, configured to communicate in a communication system, the transmitter including: one or more interfaces configured to communicate with multiple transmission-reception points (multi-TRPs) within the communication system; and a circuitry configured to: receive or transmit an indication to enable, responsive to that multi-TRP based configured grant (CG) physical uplink shared channel (PUSCH) repetition is configured, one of a plurality of beam mapping patterns by a field in a parameter of configured grant configuration.

A third aspect of the present disclosure provides a transmitter, configured to communicate in a communication system, the transmitter including: one or more interfaces configured to communicate with multiple transmission-reception points (multi-TRPs) within the communication system; and a circuitry configured to: receive or transmit an indication to indicate, by a parameter of configured grant configuration, a redundancy version (RV) offset and a configured RV sequence for multi-TRP based configured grant (CG) physical uplink shared channel (PUSCH) repetition, wherein the configured RV sequence is configured to determine a first RV sequence applied to transmission occasions associated to a first TRP, and the RV offset is configured to determine a second RV sequence applied to transmission occasions associated to a second TRP.

In an embodiment of the present disclosure with respect to the third aspect, the first RV sequence applied to the transmission occasions associated to the first TRP is configured by the configured RV sequence in the configured grant configuration, and the second RV sequence applied to the transmission occasions associated to the second TRP is determined by the RV offset from the first RV sequence.

In an embodiment of the present disclosure with respect to the third aspect, for multi-TRP based PUSCH repetition type A with type 2 CG and multi-TRP based PUSCH repetition type B with type 2 CG, a RV indicated by downlink control information (DCI) scheduling the multi-TRP based PUSCH repetition type A and type B with the type 2 CG and the configured RV sequence are used to determine the first RV sequence applied to the transmission occasions associated to the first TRP, where the RV indicated by the DCI determines a first RV value in the first RV sequence and remaining RV values in the first RV sequence are determined according to a same RV pattern as the configured RV sequence; and the second RV sequence applied to the the transmission occasions associated to the second TRP is determined by the RV offset from the first RV sequence.

A fourth aspect of the present disclosure provides a transmitter, configured to communicate in a communication system, the transmitter including: one or more interfaces configured to communicate with multiple transmission-reception points (multi-TRPs) within the communication system; and a circuitry configured to: receive or transmit an indication to indicate, by a parameter of configured grant configuration, a first redundancy version (RV) sequence and a second RV sequence for multi-TRP based configured grant (CG) physical uplink shared channel (PUSCH) repetition, wherein the first RV sequence is applied to CG PUSCH transmission occasions associated with a first TRP, and the second RV sequence is applied to CG PUSCH transmission occasions associated with a second TRP.

A fifth aspect of the present disclosure provides a transmitter, configured to communicate in a communication system, the transmitter including: one or more interfaces configured to communicate with multiple transmission-reception points (multi-TRPs) within the communication system; and a circuitry configured to: responsive to that multi-TRP based configured grant (CG) physical uplink shared channel (PUSCH) repetition type A is configured and a parameter of starting from RV0 switch in configured grant configurations set to off, for all the transmission occasions associated with a first UL beam, control an initial transmission of a transport block to only start at the first transmission occasion of all the repetitions associated with the first UL beam; and for all the transmission occasions associated with a second UL beam, control an initial transmission of a transport block to only start at the first transmission occasion of all the repetitions associated with the second UL beam; responsive to that multi-TRP based CG PUSCH repetition type B is configured and a parameter of starting from RV0 switch in the configured grant configuration is set to off, for all the transmission occasions associated with a first UL beam, control an initial transmission of a transport block to only start at the first transmission occasion of all the actual repetitions associated with the first UL beam; and for all the transmission occasions associated with a second UL beam, control an initial transmission of a transport block to only start at the first transmission occasion of all the actual repetitions associated with the second UL beam; and responsive to that multi-TRP based CG PUSCH repetition is configured and a parameter of starting from RV0 switch in the configured grant configuration is set to off, control an initial transmission of a transport block to only start at the first transmission occasion of all the repetitions associated with a dedicated UL beam, where the dedicated UL beam is configured or determined by a predefined rule.

A sixth aspect of the present disclosure provides a transmitter, configured to communicate in a communication system, the transmitter including: one or more interfaces configured to communicate with multiple transmission-reception points (multi-TRPs) within the communication system; and a circuitry configured to: receive or transmit a first starting from RV0 switch and a second starting from RV0 switch in configured grant configuration for multi-TRP based configured grant (CG) physical uplink shared channel (PUSCH) repetition, wherein responsive to that a parameter of the first starting from RV0 switch in the configured grant configuration is set to off, for all the transmission occasions associated with a first UL beam, an initial transmission of a transport block only starts at the first transmission occasion of all the repetitions associated with the first UL beam; and responsive to that a parameter of the second starting from RV0 switch in the configured grant configuration is set to off, for all the transmission occasions associated with a second UL beam, an initial transmission of a transport block only starts at the first transmission occasion of all the repetitions associated with the second UL beam.

A seventh aspect of the present disclosure provides a transmitter, configured to communicate in a communication system, the transmitter including: one or more interfaces configured to communicate with multiple transmission-reception points (multi-TRPs) within the communication system; and a circuitry configured to: responsive to multi-TRP based configured grant (CG) physical uplink shared channel (PUSCH) repetition type A, for all the transmission occasions associated with a first UL beam, responsive to that a first RV sequence to be applied to the transmission occasions associated with the first UL beam is a redundancy version (RV) pattern of {0,0,0,0}, and further responsive to that only one starting from RV0 switch is configured in configured grant configuration and the starting from RV0 switch is set to on, or two starting from RV0 switches are configured in the configured grant configuration and a first starting from RV0 switch of the two starting from RV0 switches is set to on, control an initial transmission of a transport block to start at any of transmission occasions of the repetitions associated with the first UL beam except the last transmission occasion associated with the first UL beam when the number of the repetitions is at least 8, and for all the transmission occasions associated with a second UL beam, responsive to that a the second RV sequence to be applied to the transmission occasions associated with the second UL beam is a RV pattern of {0,0,0,0}, and further responsive to that only one starting from RV0 switch is configured in configured grant configuration and the starting from RV0 switch is set to on, or two starting from RV0 switches are configured in the configured grant configuration and a second starting from RV0 switch of the two starting from RV0 switches is set to on, control an initial transmission of a transport block to start at any of transmission occasions of the repetitions associated with the second UL beam except the last transmission occasion associated with the second UL beam when the number of the repetitions is at least 8.

An eighth aspect of the present disclosure provides a transmitter, configured to communicate in a communication system, the transmitter comprising: one or more interfaces configured to communicate with multiple transmission-reception points (multi-TRPs) within the communication system; and a circuitry configured to: responsive to that multi-TRP based CG PUSCH repetition type A, for all the transmission occasions associated with a first UL beam, if a first RV sequence to be applied to the transmission occasions associated with the first UL beam is a RV pattern of {0,3,0,3} or {0,2,3,1}, and responsive to that only one starting from RV0 switch is configured in configured grant configuration and the starting from RV0 switch is set to on, or two starting from RV0 switches are configured in the configured grant configuration and a first starting from RV0 switch of the two starting from RV0 switches is set to on, control an initial transmission of a transport block to start at any of transmission occasions of the repetitions that are associated with RV=0 and are associated with the first UL beam, and for all the transmission occasions associated with a second UL beam, responsive to that a second RV sequence to be applied to the transmission occasions associated with the second UL beam is a RV pattern of {0,3,0,3} or {0,2,3,1}, and further responsive to that only one starting from RV0 switch is configured in configured grant configuration and the starting from RV0 switch is set to on, or two starting from RV0 switches are configured in the configured grant configuration and a second starting from RV0 switch of the two starting from RV0 switches is set to on, control an initial transmission of a transport block to start at any of transmission occasions of the repetitions that are associated with RV=0 and are associated with the second UL beam.

The disclosed transmitter may be implemented by a UE and the disclosed receiver may be implemented by a base station such as gNodeB, or by a TRP, for example. In other circumstance, the transmitter/receiver may be implemented by a base station such as gNodeB, or by a TRP, for example.

The disclosed transmitter may utilize a method that may be programmed as computer executable instructions stored in non-transitory computer readable medium. The non-transitory computer readable medium, when loaded to a computer, directs a processor of the computer to execute the disclosed method. The method may be programmed as computer program product, that causes a computer to execute the disclosed method.

The non-transitory computer readable medium may include at least one from a group consisting of: a hard disk, a CD-ROM, an optical storage device, a magnetic storage device, a Read Only Memory, a Programmable Read Only Memory, an Erasable Programmable Read Only Memory, EPROM, an Electrically Erasable Programmable Read Only Memory and a Flash memory.

### Advantageous Effects

Several solutions are proposed in this disclosure to support multi-TRP based CG PUSCH repetition, which include a development on indication of single-TRP/multi-TRP based CG PUSCH repetition, beam mapping, RV sequences and initial transmission occasions. First of all, regarding the indicating method, the support of single-TRP/multi-TRP based CG PUSCH repetition can be indicated by RRC and DCI. Secondly, regarding the beam mapping, the signaling of beam mapping pattern and switching gap between UL transmissions are developed. Thirdly, regarding the RV sequences, two RV sequences are developed for two sets of transmission occasions toward two TRPs based on the configured RV sequence and/or RV offset. Finally, regarding the initial transmission occasions, the initial transmission occasions for two sets of transmission occasions toward two TRPs are developed based on the starting from RV0 switch and the corresponding RV sequence. Taking these solutions into consideration, the support for CG PUSCH repetition in multi-TRP/panel scenario is greatly enhanced.

### DESCRIPTION OF DRAWINGS

In order to more clearly illustrate the embodiments of the present disclosure or related art, the following figures that will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating PUSCH repetitions in multi-TRP/panel scenario.

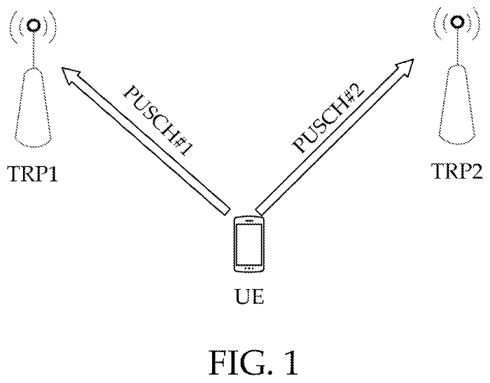

FIG. 2 is a schematic diagram illustrating a switching gab between two consecutive actual repetitions, configured when the two consecutive actual repetitions are associated with different UL beams.

FIG. 3 is a schematic diagram illustrating Type A repetition when starting from any RV0 is disabled.

FIG. 4 is a schematic diagram illustrating Type B repetition when starting from any RV0 is disabled.

FIG. 5 is a schematic diagram illustrating CG PUSCH repetition type A with RV pattern of {0,3,0,3}.

FIG. 6 is a schematic diagram illustrating CG PUSCH repetition type B with RV pattern of {0,2,3,1}.

FIG. 7 is a block diagram of an example system for wireless communication according to an embodiment of the present disclosure.

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

For easy of understanding, it is noted that in some circumstance, the term transmitter may be implemented by a UE and the term receiver may be implemented by a base station such as gNodeB, or by a TRP, for example; in other circumstance, the transmitter/receiver may be implemented by a base station such as gNodeB, or by a TRP, for example. However, this should not be taken as a limitation to interpretation of this invention.

The following abbreviations may be used in the present disclosure.

3GPP Third Generation Partnership Project

CG Configured Grant

DCI Downlink Control Information

gNB Generation Node B

MAC CE MAC Control Element

NR New Radio

PUSCH Physical Uplink Shared Channel

RAN Radio Access Network

Rel Release

RRC Radio Resource Control

RV Redundancy Version

SRS Sounding Reference Signal

SRI SRS Resource Indicator

TRP Transmission/Reception Point

UE User Equipment

UL Uplink

This invention is related to the wireless communication systems operating in multiple input multiple output (MIMO) systems. More specifically, the target is the improvement of CG PUSCH repetition in multiple transmission-reception point(multi-TRP)/panel scenario. This invention proposes some methods which are particularly interesting for enhancing the support of CG PUSCH repetition in multi-TRP/panel scenario.

If the channel between UE and one of the two TRPs may be blocked, single-TRP based CG PUSCH transmission may be more appropriate. If the channels between UE and the two TRPs are good enough, multi-TRP based CG PUSCH transmission can benefit from the increased diversity and reliability. In this disclosure, several solutions are proposed to indicated the support of single-TRP or multi-TRP based CG PUSCH transmission.

Since there may be three redundancy version (RV) sequences (i.e. {0,0,0,0}, {0,3,0,3}, {0,2,3,1}), the RV sequences for the CG PUSCH repetitions using the second UL beam toward the second TRP shall be developed in this field. For the multi-TRP based CG PUSCH repetition, since CG PUSCH repetitions are transmitted toward two TRPs using two UL beams, the RV sequences can be applied separately to PUSCH repetitions of different TRPs. In this disclosure, several solutions are proposed to develop the RV sequences that are applied separately to CG PUSCH repetitions of different TRPs.

If there are two sets of CG PUSCH transmission occasions associated with two UL beams and the initial transmission starts at the transmission occasion in only one set of CG PUSCH transmission occasions associated with one UL beam, it can increase latency when UL data is arrived after the initial transmission occasion. Hence, for multi-TRP based CG PUSCH repetition, if the initial transmission starts at the transmission occasions associated with different UL beams, it can reduce the potential latency. In this disclosure, several solutions are proposed to develop the initial transmission occasions for the two sets of CG PUSCH transmission occasions associated with two UL beams.

In short, several solutions are proposed in this disclosure to support multi-TRP based CG PUSCH repetition, which include a development on indication of single-TRP/multi-TRP based CG PUSCH repetition, beam mapping, RV sequences and initial transmission occasions. First of all, regarding the indicating method, the support of single-TRP/multi-TRP based CG PUSCH repetition can be indicated by RRC and DCI. Secondly, regarding the beam mapping, the signaling of beam mapping pattern and switching gap between UL transmissions are developed. Thirdly, regarding the RV sequences, two RV sequences are developed for two sets of transmission occasions toward two TRPs based on the configured RV sequence and/or RV offset. Finally, regarding the initial transmission occasions, the initial transmission occasions for two sets of transmission occasions toward two TRPs are developed based on the starting from RV0 switch and the corresponding RV sequence. Taking these solutions into consideration, the support for CG PUSCH repetition in multi-TRP/panel scenario is greatly enhanced.

### 1. Indication of Single-TRP/Multi-TRP Based CG PUSCH Transmission

If the channel between UE and one of the two TRPs may be blocked, UE only transmits CG PUSCH to the TRP in good condition. In this case, single-TRP based CG PUSCH transmission is applied. If the channels between UE and the two TRPs are good enough, multi-TRP based CG PUSCH transmission is applied to benefit from the increased diversity and reliability. Therefore, the support of single-TRP based CG PUSCH transmission or multi-TRP based CG PUSCH transmission shall be indicated to UE. In this section, several solutions are proposed to indicated the support of single-TRP or multi-TRP based CG PUSCH transmission.

### 1.1 RRC Configuration

Since the CG type 1 PUSCH transmission is semi-statically configured by the higher layer parameter of configured grant configuration (e.g. ConfiguredGrantConfig) including configured UL grant parameter (e.g. rrc-ConfiguredUplinkGrant) without the detection of an UL grant in a DCI and CG type 2 PUSCH transmission is semi-persistently scheduled by an UL grant in a valid activation DCI after the reception of higher layer parameter of configured grant configuration (e.g. ConfiguredGrantConfig) not including configured UL grant parameter (e.g. rrc-ConfiguredUplinkGrant), if the support of single-TRP or multi-TRP based CG PUSCH transmission is indicated by the higher layer parameter, a unified solution for PUSCH repetition with a type 1 CG and PUSCH repetition with a type 2 CG can be developed.

### 1.1.1 By Introducing a Field with 1Bit

If a field with only 1bit is added in the higher layer to indicate the support of single-TRP or multi-TRP based CG PUSCH repetition, the RRC overhead can be saved.

It is proposed that for CG PUSCH repetition (e.g. type 1 CG and type 2 CG), a field can be added in the higher layer parameter of configured grant configuration (e.g. ConfiguredGrantConfig) to indicate the support of single-TRP based CG PUSCH repetition or multi-TRP based CG PUSCH repetition. In detail, if this field is set to ‘on’ (or ‘enabled’ or ‘1’ and so on), the multi-TRP based CG PUSCH repetition is enabled; while if this field is set to ‘off’ (or ‘disabled ’ or ‘0’ and so on), the single-TRP based CG PUSCH repetition is enabled.

Regarding the indication of TRP1 or TRP2 for single-TRP based CG PUSCH repetition, other codebook and non-codebook based CG PUSCH transmission related fields (e.g. srs-ResourceIndicator and precoding AndNumberOfLayers) included in configured grant configuration (e.g. ConfiguredGrantConfig) can be used to indicate that the single-TRP based CG PUSCH is transmitted to the first TRP (e.g. TRP1) or the second TRP (e.g. TRP2).

Since there may be two higher layer parameters of SRS resource indicator (e.g. srs-ResourceIndicator) and two higher layer parameters of precoding and number of layers (e.g. precodingAndNumberOfLayers) included in configured grant configuration (e.g. ConfiguredGrantConfig), the association of these fields and TRPs can be fixed. In detail, the first SRS resource indicator (e.g. srs-ResourceIndicator1) is associated with the first TRP (e.g. TRP1) and the second SRS resource indicator (e.g. srs-ResourceIndicator2) is associated with the second TRP (e.g. TRP2). Similarly, the first precoding and number of layers (e.g. precodingAndNumberOfLayers1) is associated with the first TRP (e.g. TRP1) and the second precoding and number of layers (e.g. precodingAndNumberOfLayers2) is associated with the second TRP (e.g. TRP2). When the single-TRP based CG PUSCH is enable, several solutions are proposed to indicate one of the two TRPs to support single-TRP based CG PUSCH repetition.

### (1) By Configuring Only One Field Related to one TRP

It is proposed that for CG PUSCH repetition (e.g. type 1 CG and type 2 CG), if single-TRP based CG PUSCH repetition is enabled, and if only one of the two higher layer parameters of SRS resource indicator (e.g. srs-ResourceIndicator) is configured and/or only one of the two higher layer parameters of precoding and number of layers (e.g. precodingAndNumberOfLayers) is configured, the CG PUSCH is transmitted to the TRP whose associated SRS resource indicator (e.g. srs-ResourceIndicator) and/or precoding and number of layers (e.g. precodingAndNumberOfLayers) is configured.

In detail, if only the first SRS resource indicator (e.g. srs-ResourceIndicator1) of the two SRS resource indicators and/or only the first precoding and number of layers (e.g. precoding AndNumberOfLayers1) of the two precoding and number of layers is configured, the CG PUSCH is only transmitted to the first TRP; if only the second SRS resource indicator (e.g. srs-ResourceIndicator2) of the two SRS resource indicators and/or only the second precoding and number of layers (e.g. precodingAndNumberOfLayers2) of the two precoding and number of layers is configured, the CG PUSCH is only transmitted to the second TRP.

### (2) By configuring the dedicated values for the field related to the unused TRP

It is proposed that for CG PUSCH repetition (e.g. type 1 CG and type 2 CG), if single-TRP based CG PUSCH repetition is enabled, and if two higher layer parameters of SRS resource indicator (e.g. srs-ResourceIndicator) are configured and/or two higher layer parameters of precoding and number of layers (e.g. precodingAndNumberOfLayers) are configured, the CG PUSCH is transmitted to the TRP whose associated SRS resource indicator (e.g. srs-ResourceIndicator) and/or precoding and number of layers (e.g. precoding AndNumberOfLayers) is not configured with the dedicated values.

The dedicated values can be an invalid value or the minimum value of the corresponding field (e.g. ‘0’) or the maximum value of the corresponding field. In detail, if the value provided by the first SRS resource indicator (e.g. srs-ResourceIndicator1) of the two SRS resource indicators is a dedicated value (e.g. an invalid value or the minimum value of the field (e.g. ‘0’) or the maximum value of the field) and/or the value provided by the first precoding and number of layers (e.g. precodingAndNumberOfLayers1) of the two precoding and number of layers is a dedicated value (e.g. an invalid value or the minimum value of the field (e.g. ‘0’) or the maximum value of the field), the CG PUSCH is only transmitted to the second TRP; if the value provided by the second SRS resource indicator (e.g. srs-ResourceIndicator2) of the two SRS resource indicators is a dedicated value (e.g. an invalid value or the minimum value of the field (e.g. ‘0’) or the maximum value of the field) and/or the value provided by the second precoding and number of layers (e.g. precodingAndNumberOfLayers2) of the two precoding and number of layers is a dedicated value (e.g. an invalid value or the minimum value of the field (e.g. ‘0’) or the maximum value of the field), the CG PUSCH is only transmitted to the first TRP.

### (3) By Configuring a Valid Spatial Relation for one TRP

Since there may be two spatial relations and each spatial relation corresponds to one TRP respectively, for single-TRP based CG PUSCH repetition, one spatial relation corresponding to one of the two TRPs can be configured with a valid value and the other spatial relation corresponding to the other TRP can be configured with an invalid value. By this way, the CG PUSCH is transmitted to the TRP with a valid spatial relation and one of the two TRPs is determined.

It is proposed that for CG PUSCH repetition (e.g. type 1 CG and type 2 CG), if single-TRP based CG PUSCH repetition is enabled, and if only one of the two spatial relations is configured with a valid value, the CG PUSCH is transmitted to the TRP whose associated spatial relation is configured with a valid value.

### 1.1.2 By Introducing a Field with More Bits

If a field with more that 1 bit is added in the higher layer to indicated the support of single-TRP or multi-TRP based CG PUSCH repetition, it is a more straightforward way.

Regarding the single-TRP based CG PUSCH repetition, there are two potential schemes, i.e. single-TRP based CG PUSCH repetition with the first TRP and single-TRP based CG PUSCH repetition with the second TRP. In total, there are three potential schemes, i.e. single-TRP based CG PUSCH repetition with the first TRP (e.g. TRP1), single-TRP based CG PUSCH repetition with the second TRP (e.g. TRP2) and multi-TRP based CG PUSCH repetition. In other word, the UE is configured with one of the three schemes above.

It is proposed that for CG PUSCH repetition (e.g. type 1 CG and type 2 CG), a field can be added in the higher layer parameter of configured grant configuration (e.g. ConfiguredGrantConfig) to indicate one of the three schemes, i.e. single-TRP based CG PUSCH repetition with the first TRP, single-TRP based CG PUSCH repetition with the second TRP and multi-TRP based CG PUSCH repetition. In detail, when single-TRP based CG PUSCH repetition with the first TRP is enabled, the CG PUSCH is only transmitted to the first TRP; when single-TRP based CG PUSCH repetition with the second TRP is enabled, the CG PUSCH is only transmitted to the second TRP; when multi-TRP based CG PUSCH repetition is enabled, the CG PUSCH is transmitted to the first TRP and second TRP.

### 1.2 DCI Configuration

Since CG type 2 PUSCH transmission is semi-persistently scheduled by an UL grant in a valid activation DCI after the reception of higher layer parameter of configured grant configuration (e.g. ConfiguredGrantConfig) not including configured UL grant parameter (e.g. rrc-ConfiguredUplinkGrant), the support of single-TRP or multi-TRP based CG PUSCH transmission can be dynamically indicated by the DCI scheduling the CG type 2 PUSCH transmission. Therefore, a field can be added in the DCI scheduling the CG type 2 PUSCH transmission to indicate the support of single-TRP based CG PUSCH repetition or multi-TRP based CG PUSCH repetition.

### 1.2.1 By Introducing a Field with 1Bit

It is proposed that for PUSCH repetition with type 2 CG, if bit width of the field added in the DCI scheduling the PUSCH repetition with type 2 CG is 1 bit and this field is set to ‘1’ (or ‘enabled’ and so on), the multi-TRP based CG PUSCH repetition is enabled; while if this field is set to ‘0’ (or ‘disabled ’ and so on), the single-TRP based CG PUSCH repetition is enabled.

Since there may be two spatial relations and each spatial relation corresponds to one TRP respectively, for single-TRP based CG PUSCH repetition, one spatial relation corresponding to one of the two TRPs can be configured with a valid value and the other spatial relation corresponding to the other TRP can be configured with an invalid value. By this way, the CG PUSCH is transmitted to the TRP with a valid spatial relation and one of the two TRPs is determined.

It is proposed that for PUSCH repetition with type 2 CG, if single-TRP based CG PUSCH repetition is enabled, and if only one of the two spatial relations is configured with a valid value, the CG PUSCH is transmitted to the TRP whose associated spatial relation is configured with a valid value.

### 1.2.2 By Introducing a Field with 2Bits

If a field with 2 bits is added in the DCI scheduling the PUSCH repetition with type 2 CG, it is a more straightforward way. Regarding the single-TRP based CG PUSCH repetition, there are two potential schemes, i.e. single-TRP based CG PUSCH repetition with the first TRP and single-TRP based CG PUSCH repetition with the second TRP. In total, there are three potential schemes, i.e. single-TRP based CG PUSCH repetition with the first TRP (e.g. TRP1), single-TRP based CG PUSCH repetition with the second TRP (e.g. TRP2) and multi-TRP based CG PUSCH repetition. In other word, one of the three schemes is indicated to UE.

Regarding the development of the field with 2 bits, there are two solutions. On the one hand, the overall 2 bits can indicate up to four values and each value corresponding to one of the three schemes. It is proposed that for PUSCH repetition with type 2 CG, if bit width of the field added in the DCI scheduling the PUSCH repetition with type 2 CG is 2 bits, each value of the field corresponds to one of the three schemes (i.e. single-TRP based CG PUSCH repetition with the first TRP (e.g. TRP1), single-TRP based CG PUSCH repetition with the second TRP (e.g. TRP2) and multi-TRP based CG PUSCH repetition) and the last value of the field is reserved. For an example, when the value of the field is 0, 1 and 2, the corresponding schemes are single-TRP based CG PUSCH repetition with the first TRP (e.g. TRP1), single-TRP based CG PUSCH repetition with the second TRP (e.g. TRP2) and multi-TRP based CG PUSCH repetition, respectively.

On the other hand, one of the two bits can be used to indicate whether it is single-TRP based CG PUSCH repetition or multi-TRP based CG PUSCH repetition. If single-TRP based CG PUSCH repetition is enabled, the other bit can be used to indicate whether it is the first TRP or the second TRP.

It is proposed that for PUSCH repetition with type 2 CG, if bit width of the field added in the DCI scheduling the PUSCH repetition with type 2 CG is 2 bits, when the value of the first bit of the field is ‘1’, the multi-TRP based CG PUSCH repetition is enabled; when the value of the first bit of the field is ‘0’, the single-TRP based CG PUSCH repetition is enabled, and vice versa. If the single-TRP based CG PUSCH repetition is enabled, when the value of the second bit of the field is ‘1’, the first TRP is enabled, i.e. single-TRP based CG PUSCH repetition with the first TRP (e.g. TRP1); when the value of the second bit of the field is ‘0’, the second TRP is enabled, i.e. single-TRP based CG PUSCH repetition with the second TRP (e.g. TRP2), and vice versa.

### 2 Beam Mapping

### 2.1 Signaling of Beam Mapping Pattern

Since there may be three potential beam mapping patterns (e.g. cyclical mapping pattern, sequential mapping pattern and half-half mapping pattern) for CG PUSCH repetitions, one of the three beam mapping patterns should be configured for UE.

It is proposed that when multi-TRP based CG PUSCH repetition is configured (e.g. by the higher layer parameter repK), a field can be added in the higher layer parameter of configured grant configuration (e.g. ConfiguredGrantConfig) to enable one of the beam mapping patterns. In detail, when the cyclical mapping pattern is enabled, the first and second UL beams are applied to the first and second CG PUSCH repetition, respectively, and the same beam mapping pattern continues to the remaining CG PUSCH repetitions. When the sequential mapping pattern is enabled, the first UL beam is applied to the first and second CG PUSCH repetitions, and the second UL beam is applied to the third and fourth CG PUSCH repetitions, and the same beam mapping pattern continues to the remaining CG PUSCH repetitions. When the half-half mapping pattern is enabled, the first beam is applied to the first half of CG PUSCH repetitions, and the second beam is applied to the second half of CG PUSCH repetitions. Specially, since the cyclical mapping pattern has more power consumption due to more frequent beam switching events, the support of the cyclical mapping pattern can be optional UE feature for the cases when the number of repetitions is larger than 2. Here, if the CG PUSCH repetition type B is configured, the repetition mentioned above is the nominal repetition. In other word, one CG PUSCH transmission occasion is associated to one nominal repetition.

### 2.2 Switching Gap Between UL Transmissions Towards Two TRPs

For CG PUSCH repetition type B, due to the crossing slot boundary or invalid symbols, a nominal repetition is divided into multiple actual repetitions. If two consecutive actual repetitions are associated with different UL beams, it needs the time to switch from one beam to another. Hence, a time gap (i.e. switching gab/transient period(s)) between two consecutive actual repetitions is needed when two actual repetitions are associated with different UL beams. The switching gab may be different depending on whether the UL beams are from the same or different panels. In detail, the switching gab when the UL beams are from the same panel may be smaller than the switching gab when the UL beams are from the different panels.

It is proposed that for CG PUSCH repetition type B, a switching gap between two actual repetitions is needed when two actual repetitions are associated with different UL beams. The switching gap can be predefined depending on whether the UL beams are from the same or different panels. In addition, the switching gap can be configured by RRC/MAC CE/DCI. For example, the switching gap can be 5 us when two beams are switched within the same panel; the switching gap can be 10 us when two beams are from the different panels.

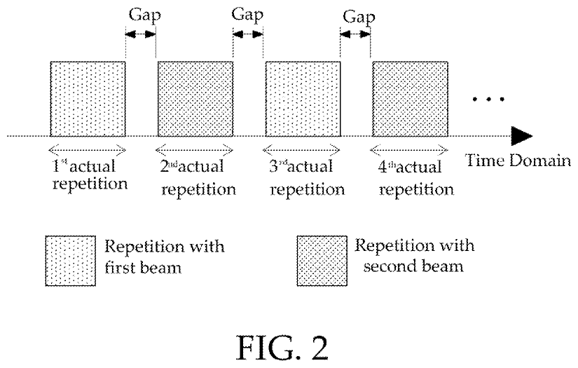

As is shown in the FIG. 2, a switching gab between two consecutive actual repetitions is configured when two actual repetitions are associated with different UL beams.

### 3 RV Mapping

For the single-TRP based PUSCH transmission, one of the three RV sequences (i.e. {0,0,0,0}, {0,3,0,3}, {0,2,3,1}) can be configured by the higher layer parameter of redundancy version sequence (e.g. repK-RV) in the higher layer parameter of configured grant configuration (e.g. ConfiguredGrantConfig). For the multi-TRP based CG PUSCH repetition, since CG PUSCH repetitions are transmitted toward two TRPs using two UL beams, the RV sequences can be applied separately to PUSCH repetitions of different TRPs. In this section, several solutions are proposed to develop the RV sequences that are applied separately to CG PUSCH repetitions of different TRPs.

For CG PUSCH repetition type B, the UL beam is mapped based on nominal repetition. In other words, nominal repetitions are used to map beams. For CG PUSCH repetition type B, due to the crossing slot boundary or invalid symbols, a nominal repetition is divided into multiple actual repetitions. If the redundancy version is selected based on actual repetition, one nominal repetition is associated with one beam and each actual repetition of this nominal repetition is associated with one RV in the RV sequence.

### 3.1 One RV Sequence Configured by Higher Layer Parameter

### 3.1.1 Signaling of RV Offset

In order to achieve best coding combining gain, RV sequences should be supported for CG PUSCH repetitions with the same UL beam (i.e. per TRP). For CG PUSCH repetition, a RV sequence can be configured by the higher layer parameter of redundancy version sequence (e.g. repK-RV) in the higher layer parameter of configured grant configuration (e.g. ConfiguredGrantConfig) and the configured RV sequence is applied to transmission occasions associated to the first TRP (i.e. the first UL beam). The RV sequence associated to the second TRP (i.e. the second UL beam) is determined by a RV offset from that configured RV sequence whereas the offset is RRC configured.

It is proposed that for multi-TRP based CG PUSCH repetition, a field can be added in the higher layer parameter of configured grant configuration (e.g. ConfiguredGrantConfig) to indicate the RV offset from that configured RV sequence (e.g. repK-RV) and then the RV sequence associated to the second TRP (i.e. the second UL beam) is determined by this RV offset and the configured RV sequence.

### 3.1.2 RV Mapping Based on Higher Layer Parameter

Regarding CG PUSCH repetition type B, one CG PUSCH transmission occasion is associated to one actual repetition. Since the CG type 1 PUSCH transmission is semi-statically configured by the higher layer parameter of configured grant configuration (e.g. ConfiguredGrantConfig) including configured UL grant parameter (e.g. rrc-ConfiguredUplinkGrant) without the detection of an UL grant in a DCI and CG type 2 PUSCH transmission is semi-persistently scheduled by an UL grant in a valid activation DCI after the reception of higher layer parameter of configured grant configuration (e.g. ConfiguredGrantConfig) not including configured UL grant parameter (e.g. rrc-ConfiguredUplinkGrant), if the RV sequences associated to the two TRPs are only determined based on the higher layer parameter of redundancy version sequence (e.g. repK-RV) and the RV offset in the configured grant configuration (e.g. ConfiguredGrantConfig), a unified solution for PUSCH repetition with a type 1 CG and PUSCH repetition with a type 2 CG can be developed.

It is proposed that for multi-TRP based CG PUSCH repetition type B, if the redundancy version sequence (e.g. repK-RV) is provided in the higher layer parameter of configured grant configuration (e.g. ConfiguredGrantConfig), the first RV sequence is configured by the redundancy version sequence (e.g. repK-RV) in the configured grant configuration (e.g. ConfiguredGrantConfig) and the first RV sequence is applied to transmission occasions associated to the first TRP (i.e. the first UL beam). In detail, for the n th transmission occasion among all the actual repetitions of the nominal repetitions associated with the first TRP (i.e. the first UL beam), it is associated with (mod(n−1,4)+1)th value in the first RV sequence, where n is counted only considering CG PUSCH transmission occasions associated with the first UL beam. The second RV sequence is determined by a RV offset from the first RV sequence, where the RV offset is configured by a higher layer parameter included in the configured grant configuration (e.g. ConfiguredGrantConfig) and the second RV sequence is applied to transmission occasions associated to the second TRP (i.e. the second UL beam). In detail, for the m th transmission occasion among all the actual repetitions of the nominal repetitions associated with the second TRP (i.e. the second UL beam), it is associated with (mod(m−1,4)+1)th value in the second RV sequence, where m is counted only considering CG PUSCH transmission occasions associated with the second UL beam. Specially, if the redundancy version sequence (e.g. repK-RV) is not provided in the configured grant configuration (e.g. ConfiguredGrantConfig), the RVs for all the actual repetitions associated to the two TRPs shall be set to 0.

Based on the above analysis, for all CG PUSCH transmission occasions associated with the first UL beam (i.e. the first TRP), when the configured RV sequence (e.g. repK-RV) is {0,0,0,0}, {0,3,0,3} and {0,2,3,1}, the RV to be applied is derived according to Table 1, Table 3 and Table 5 respectively, where n is an integer and is counted only considering CG PUSCH transmission occasions associated with the first UL beam; the RV for CG PUSCH transmission occasions associated with the second UL beam (i.e. the second TRP) is derived according to Table 2, Table 4 and Table 6 respectively, where RV_{offset} is configured by higher layer parameter included in the configured grant configuration (e.g. ConfiguredGrantConfig), and m is an integer and is counted only considering CG PUSCH transmission occasions associated with the second UL beam. Here, regarding CG PUSCH repetition type B, one CG PUSCH transmission occasion is associated to one actual repetition. Specially, the following tables can also be applied to CG PUSCH repetition type A when one CG PUSCH transmission occasion is associated to one repetition.

### (1) The Configured RV Sequence is {0,0,0,0}

TABLE 1
RVs for the first TRP
RV to be applied to nth transmission occasion

| n mod 4 = 0 | n mod 4 = 1 | n mod 4 = 2 | n mod 4 = 3 |
|---|---|---|---|
| 0 | 0 | 0 | 0 |

TABLE 2
RVs for the second TRP
RV to be applied to mth transmission occasion

| m mod 4 = 0 | m mod 4 = 1 | m mod 4 = 2 | m mod 4 = 3 |
|---|---|---|---|
| (0 + RV_{offset}) | (0 + RV_{offset}) | (0 + RV_{offset}) | (0 + RV_{offset}) |
| mod 4 | mod 4 | mod 4 | mod 4 |

### (2) The Configured RV Sequence is {0,3,0,3}

TABLE 3
RVs for the first TRP
RV to be applied to nth transmission occasion

| n mod 4 = 0 | n mod 4 = 1 | n mod 4 = 2 | n mod 4 = 3 |
|---|---|---|---|
| 0 | 3 | 0 | 3 |

TABLE 4
RVs for the second TRP
RV to be applied to mth transmission occasion

| m mod 4 = 0 | m mod 4 = 1 | m mod 4 = 2 | m mod 4 = 3 |
|---|---|---|---|
| (0 + RV_{offset}) | (3 + RV_{offset}) | (0 + RV_{offset}) | (3 + RV_{offset}) |
| mod 4 | mod 4 | mod 4 | mod 4 |

### (3) The Configured RV Sequence is {0,2,3,1}

TABLE 5
RVs for the first TRP
RV to be applied to nth transmission occasion

| n mod 4 = 0 | n mod 4 = 1 | n mod 4 = 2 | n mod 4 = 3 |
|---|---|---|---|
| 0 | 2 | 3 | 1 |

TABLE 6
RVs for the second TRP
RV to be applied to mth transmission occasion

| m mod 4 = 0 | m mod 4 = 1 | m mod 4 = 2 | m mod 4 = 3 |
|---|---|---|---|
| (0 + RV_{offset}) | (2 + RV_{offset}) | (3 + RV_{offset}) | (1 + RV_{offset}) |
| mod 4 | mod 4 | mod 4 | mod 4 |

### 3.1.3 RV Mapping Based on Higher Layer Parameter and DCI

The PUSCH repetition with a type 2 CG is semi-persistently scheduled by an UL grant in a valid activation DCI after the reception of higher layer parameter of configured grant configuration (e.g. ConfiguredGrantConfig) not including configured UL grant parameter (e.g. rrc-ConfiguredUplinkGrant). If the RV for the first PUSCH transmission occasion is indicated by the DCI scheduling the PUSCH repetition with a type 2 CG, the RV for the for PUSCH transmission occasions with type 2 CG can be dynamically changed.

It is proposed that for multi-TRP based PUSCH repetition type A with type 2 CG and PUSCH repetition type B with type 2 CG, if the redundancy version sequence (e.g. repK-RV) is provided in the higher layer parameter of configured grant configuration (e.g. ConfiguredGrantConfig), a RV sequence is configured by the redundancy version sequence (e.g. repK-RV) in the configured grant configuration (e.g. ConfiguredGrantConfig), and RV indicated by DCI scheduling the PUSCH repetition with a type 2 CG and the configured RV sequence are used to determine the first RV sequence to be applied to transmission occasions associated to the first TRP (i.e. the first UL beam), where the RV indicated by DCI determines the first RV in the first RV sequence and the remaining RVs in the first RV sequence are determined according to the same RV pattern as the configured RV sequence. The second RV sequence is determined by a RV offset from the first RV sequence, where the RV offset is configured by a higher layer parameter included in the configured grant configuration (e.g. ConfiguredGrantConfig) and the second RV sequence is applied to transmission occasions associated to the second TRP (i.e. the second UL beam). Specially, if the redundancy version sequence (e.g. repK-RV) is not provided in the configured grant configuration (e.g. ConfiguredGrantConfig), the RVs for all the CG PUSCH transmission occasions associated to the two TRPs shall be set to 0.

Based on the above analysis, for all CG PUSCH transmission occasions associated with the first UL beam (i.e. the first TRP), when the configured RV sequence (e.g. repK-RV) is {0,0,0,0}, {0,3,0,3} and {0,2,3,1}, the RV to be applied is derived according to Table 7, Table 9 and Table 11 respectively, where n is an integer and is counted only considering CG PUSCH transmission occasions associated with the first UL beam; the RV for CG PUSCH transmission occasions associated with the second UL beam (i.e. the second TRP) is derived according to Table 8, Table 10 and Table 12 respectively, where RV_{offset} is configured by higher layer parameter included in the configured grant configuration (e.g. ConfiguredGrantConfig) and m is an integer and is counted only considering CG PUSCH transmission occasions associated with the second UL beam. Here, for PUSCH repetition type A with type 2 CG, one CG PUSCH transmission occasion is associated to one repetition; while for PUSCH repetition type B with type 2 CG, one CG PUSCH transmission occasion is associated to one actual repetition.

### (1) The Configured RV Sequence is {0,0,0,0}

TABLE 7
RVs for the first TRP

| RV indicated | RV to be applied to nth transmission occasion | | | |
|---|---|---|---|---|
| by the DCI | n mod 4 = 0 | n mod 4 = 1 | n mod 4 = 2 | n mod 4 = 3 |
| 0 | 0 | 0 | 0 | 0 |

TABLE 8
RVs for the second TRP

| RV indicated | RV to be applied to mth transmission occasion | | | |
|---|---|---|---|---|
| by the DCI | m mod 4 = 0 | m mod 4 = 1 | m mod 4 = 2 | m mod 4 = 3 |
| 0 | (0 + RV_{offset}) | (0 + RV_{offset}) | (0 + RV_{offset}) | (0 + RV_{offset}) |
| | mod 4 | mod 4 | mod 4 | mod 4 |

### (2) The Configured RV Sequence is {0,3,0,3}

TABLE 9
RVs for the first TRP

| RV indicated | RV to be applied to nth transmission occasion | | | |
|---|---|---|---|---|
| by the DCI | n mod 4 = 0 | n mod 4 = 1 | n mod 4 = 2 | n mod 4 = 3 |
| 0 | 0 | 3 | 0 | 3 |
| 3 | 3 | 0 | 3 | 0 |

TABLE 10
RVs for the second TRP

| RV indicated | RV to be applied to mth transmission occasion | | | |
|---|---|---|---|---|
| by the DCI | m mod 4 = 0 | m mod 4 = 1 | m mod 4 = 2 | m mod 4 = 3 |
| 0 | (0 + RV_{offset}) | (3 + RV_{offset}) | (0 + RV_{offset}) | (3 + RV_{offset}) |
| | mod 4 | mod 4 | mod 4 | mod 4 |
| 3 | (3 + RV_{offset}) | (0 + RV_{offset}) | (3 + RV_{offset}) | (0 + RV_{offset}) |
| | mod 4 | mod 4 | mod 4 | mod 4 |

### (3) The Configured RV Sequence is {0,2,3,1}

TABLE 11
RVs for the first TRP

| RV indicated | RV to be applied to nth transmission occasion | | | |
|---|---|---|---|---|
| by the DCI | n mod 4 = 0 | n mod 4 = 1 | n mod 4 = 2 | n mod 4 = 3 |
| 0 | 0 | 2 | 3 | 1 |
| 2 | 2 | 3 | 1 | 0 |
| 3 | 3 | 1 | 0 | 2 |
| 1 | 1 | 0 | 2 | 3 |

TABLE 12
RVs for the second TRP

| RV indicated | RV to be applied to mth transmission occasion | | | |
|---|---|---|---|---|
| by the DCI | m mod 4 = 0 | m mod 4 = 1 | m mod 4 = 2 | m mod 4 = 3 |
| 0 | (0 + RV_{offset}) | (2 + RV_{offset}) | (3 + RV_{offset}) | (1 + RV_{offset}) |
| | mod 4 | mod 4 | mod 4 | mod 4 |
| 2 | (2 + RV_{offset}) | (3 + RV_{offset}) | (1 + RV_{offset}) | (0 + RV_{offset}) |
| | mod 4 | mod 4 | mod 4 | mod 4 |
| 3 | (3 + RV_{offset}) | (1 + RV_{offset}) | (0 + RV_{offset}) | (2 + RV_{offset}) |
| | mod 4 | mod 4 | mod 4 | mod 4 |
| 1 | (1 + RV_{offset}) | (0 + RV_{offset}) | (2 + RV_{offset}) | (3 + RV_{offset}) |
| | mod 4 | mod 4 | mod 4 | mod 4 |

### 3.2 Two RV Sequences Configured by Higher Layer Parameter

To simplify the procedure of RV mapping and provide various RV sequences for the two TRPs, a second RV sequence (e.g. repK-RV) to be applied to the second TRP can be added in the higher layer parameter of configured grant configuration (e.g. ConfiguredGrantConfig).

It is proposed that for multi-TRP based CG PUSCH repetition, a second RV sequence (e.g. repK-RV) can be added in the higher layer parameter of configured grant configuration (e.g. ConfiguredGrantConfig), and the first RV sequence configured by the higher layer parameter of first RV sequence (e.g. repK-RV1) in the configured grant configuration (e.g. ConfiguredGrantConfig) is applied to the CG PUSCH transmission occasions associated with the first UL beam (i.e. the first TRP), and the second RV sequence configured by the higher layer parameter of second RV sequence (e.g. repK-RV2) in the configured grant configuration (e.g. ConfiguredGrantConfig) is applied to the CG PUSCH transmission occasions associated with the second UL beam (i.e. the second TRP).

In detail, if the two RV sequences (e.g. repK-RV) are provided in the configured grant configuration (e.g. ConfiguredGrantConfig), for the n th transmission occasion associated with the first UL beam (i.e. the first TRP), it is associated with (mod(n−1,4)+1)th value in the first RV sequence, where n is an integer and is counted only considering CG PUSCH transmission occasions associated with the first UL beam. For the m th transmission occasion associated with the second UL beam (i.e. the second TRP), it is associated with (mod(m−1,4)+1)th value in the second RV sequence, where m is an integer and is counted only considering CG PUSCH transmission occasions associated with the second UL beam. Specially, if the two RV sequences (e.g. repK-RV) is not provided in the configured grant configuration (e.g. ConfiguredGrantConfig), the RVs for all the CG PUSCH transmission occasions associated to the two TRPs shall be set to 0. By default, if single-TRP based CG PUSCH repetition is enabled, the RV sequence configured by the higher layer parameter of first RV sequence (e.g. repK-RV1) in the configured grant configuration (e.g. ConfiguredGrantConfig) is applied to all the CG PUSCH transmission occasions associated with the TRP. Here, for PUSCH repetition type A, one CG PUSCH transmission occasion is associated to one repetition; while for PUSCH repetition type B, one CG PUSCH transmission occasion is associated to one actual repetition.

Based on the above analysis, for all CG PUSCH transmission occasions associated with the first UL beam (i.e. the first TRP), when the first configured RV sequence (e.g. repK-RV1) is {0,0,0,0}, {0,3,0,3} and {0,2,3,1}, the RV to be applied is derived according to Table 1, Table 3 and Table 5 respectively. For all CG PUSCH transmission occasions associated with the second UL beam (i.e. the second TRP), when the second configured RV sequence (e.g. repK-RV2) is {0,0,0,0}, {0,3,0,3} and {0,2,3,1}, the RV to be applied is derived according to Table 1, Table 3, Table 5 respectively.

### 4. Transmission Occasion for Initial Transmission

### 4.1 Disable the Feature of Starting from Any RV0

To reduce the initial transmission delay and introduce the high reliability by using all UL symbols of the CG PUSCH transmission occasion, a higher layer parameter of starting from RV0 switch (e.g. startingFromRV0-r16) is introduced to restrict UE that can only start from the first transmission occasion. Since there are two TRPs, one or two higher layer parameters of starting from RV0 switch can be configured to indicate the restriction.

### 4.1.1 One Starting from RV0 Switch

For multi-TRP based CG PUSCH repetition, if a single starting from RV0 switch is used to indicate the same restriction that UE can only start from the first transmission occasion associated with the first UL beam and the first transmission occasion associated with the second UL beam, the signaling overhead can be reduced.

Since there are two sets of CG PUSCH transmission occasions associated with two UL beams respectively, if the initial transmission of a transport block starts at the first transmission occasions associated with different UL beams, it can benefit from the increased diversity and reliability. It is proposed that if multi-TRP based CG PUSCH repetition type A is configured and the higher layer parameter of starting from RV0 switch (e.g. startingFromRV0-r16) in the configured grant configuration (e.g. ConfiguredGrantConfig) is set to ‘off’, for all the transmission occasions associated with the first UL beam, the initial transmission of a transport block may only start at the first transmission occasion of all the repetitions associated with the first UL beam (i.e. the first TRP); while for all the transmission occasions associated with the second UL beam, the initial transmission of a transport block may only start at the first transmission occasion of all the repetitions associated with the second UL beam (i.e. the second TRP).

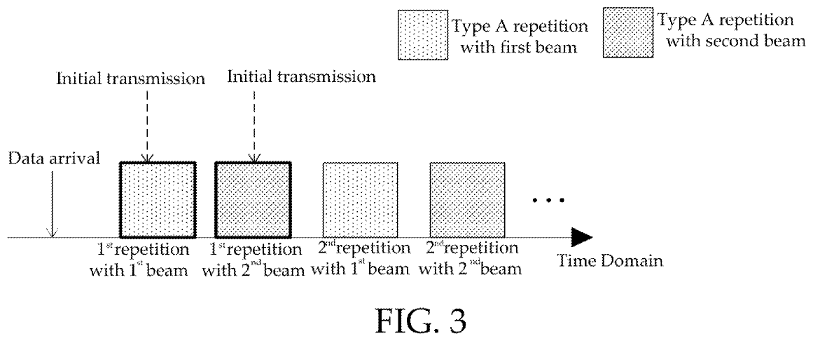

For the cases of CG PUSCH repetition type A with cyclic beam mapping pattern, as is shown in FIG. 3, when the starting from RV0 switch is set to ‘off’, the initial transmission of a transport block may only start at the first repetition with the first beam and the first repetition with the second beam.

It is proposed that if multi-TRP based CG PUSCH repetition type B is configured and the higher layer parameter of starting from RV0 switch (e.g. startingFromRV0-r16) in the configured grant configuration (e.g. ConfiguredGrantConfig) is set to ‘off’, for all the transmission occasions associated with the first UL beam, the initial transmission of a transport block may only start at the first transmission occasion of all the actual repetitions associated with the first UL beam (i.e. the first TRP); while for all the transmission occasions associated with the second UL beam, the initial transmission of a transport block may only start at the first transmission occasion of all the actual repetitions associated with the second UL beam (i.e. the second TRP).

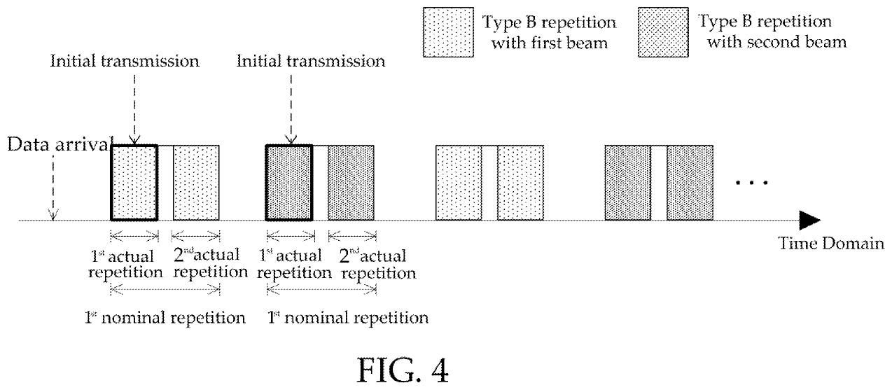

For the cases of CG PUSCH repetition type B with cyclic beam mapping pattern, as is shown in FIG. 4, when the starting from RV0 switch is set to ‘off’, the initial transmission of a transport block may only start at the first actual repetition with the first beam and the first actual repetition with the second beam.

On the other hand, if the initial transmission of a transport block starts at the first transmission occasions associated with a dedicated UL beam (e.g. the first UL beam or second UL beam), UE can select the initial transmission occasion with a simple solution. It is proposed that if multi-TRP based CG PUSCH repetition is configured and the higher layer parameter of starting from RV0 switch (e.g. startingFromRV0-r16) in the configured grant configuration (e.g. ConfiguredGrantConfig) is set to ‘off’, the initial transmission of a transport block may only start at the first transmission occasion of all the repetitions associated with a dedicated UL beam (e.g. the first UL beam or second UL beam), where the dedicated UL beam is determined by a predefined rule or configured by the gNB.

Here, if the CG PUSCH repetition is CG PUSCH repetition type B, the repetition mentioned above is the actual repetition. In other word, one CG PUSCH transmission occasion is associated to one actual repetition.

### 4.1.2 Two Starting from RV0 Switches

For multi-TRP based CG PUSCH repetition, if there are two starting from RV0 switches, they can be separately used to indicate the restriction that UE can only start from the first transmission occasion associated with the first UL beam and the first transmission occasion associated with the second UL beam respectively.

It is proposed that for multi-TRP based CG PUSCH repetition (e.g. type A and type B), a second starting from RV0 switch (e.g. startingFromRV0-r16) can be added in the configured grant configuration (e.g. ConfiguredGrantConfig) to indicate the restriction that UE can only start from the first transmission occasion of all the transmission occasions associated with the second UL beam. In detail, if the higher layer parameter of the first starting from RV0 switch (e.g. startingFromRV0-r16-1) in the configured grant configuration (e.g. ConfiguredGrantConfig) is set to ‘off’, for all the transmission occasions associated with the first UL beam, the initial transmission of a transport block may only start at the first transmission occasion of all the repetitions associated with the first UL beam (i.e. the first TRP). If the higher layer parameter of the second starting from RV0 switch (e.g. startingFromRV0-r16-2) in the configured grant configuration (e.g. ConfiguredGrantConfig) is set to ‘off’, for all the transmission occasions associated with the second UL beam, the initial transmission of a transport block may only start at the first transmission occasion of all the repetitions associated with the second UL beam (i.e. the second TRP). Here, if the CG PUSCH repetition is CG PUSCH repetition type B, the repetition mentioned above is the actual repetition. In other word, one CG PUSCH transmission occasion is associated to one actual repetition.

### 4.2 Enable the Feature of Starting from Any RV0

If there are two sets of CG PUSCH transmission occasions associated with two UL beams and the initial transmission starts at the transmission occasion with RV0 in only one set of CG PUSCH transmission occasions associated with one UL beam, it can increase latency when UL data is arrived after the transmission occasion with RV0. Hence, for multi-TRP based CG PUSCH repetition, if the initial transmission of a transport block starts at the transmission occasions associated with different UL beams, it can reduce the potential latency. In addition, it can benefit from the increased diversity and reliability.

Regarding the development on starting from RV0 switch, one or two higher layer parameters of starting from RV0 switch can be configured to indicate the restriction. For multi-TRP based CG PUSCH repetition, if only one starting from RV0 switch (e.g. startingFromRV0-r16) is configured in the higher layer parameter of the configured grant configuration (e.g. ConfiguredGrantConfig), the same starting from RV0 switch is used to enable the feature of starting from any transmission occasion with RV0 in two sets of CG PUSCH transmission occasions associated with two UL beams. On the other hand, a second starting from RV0 switch (e.g. startingFromRV0-r16) can be added in the configured grant configuration (e.g. ConfiguredGrantConfig) to enable the feature of starting from any transmission occasion with RV0 in the second set of CG PUSCH transmission occasions associated with the second UL beam. In detail, the first starting from RV0 switch (e.g. startingFromRV0-r16-1) in the configured grant configuration (e.g. ConfiguredGrantConfig) is used to enable the feature of starting from any transmission occasion with RV0 in the first set of CG PUSCH transmission occasions associated with the first UL beam (i.e. the first TRP); while the second starting from RV0 switch (e.g. startingFromRV0-r16-2) in the configured grant configuration (e.g. ConfiguredGrantConfig) is used to enable the feature of starting from any transmission occasion with RV0 in the second set of CG PUSCH transmission occasions associated with the second UL beam (i.e. the second TRP).

Regarding the RV sequences for the two TRPs, the first RV sequence to be applied to the transmission occasions associated with the first UL beam (i.e. the first TRP) and the second RV sequence to be applied to the transmission occasions associated with the second UL beam (i.e. the second TRP) are determined based on the RV related parameters (e.g. the higher layer parameter of RV sequence (e.g. repK-RV) in the configured grant configuration (e.g. ConfiguredGrantConfig) and the RV offset).

Regarding the RV patterns, the following RV sequences, i.e., {0,2,3,1}, {2,3,1,0}, {3,1,0,2}, {1,0,2,3}, have the same RV pattern, i.e., {0,2,3,1}. The following RV sequences, i.e., {0,3,0,3}, {3,0,3,0}, have the same RV pattern, i.e., {0,3,0,3}. The RV pattern, i.e., {0,0,0,0} has only one RV sequence, i.e., {0,0,0,0}. Since there are three potential RV patterns (i.e. {0,0,0,0}, {0,3,0,3}, {0,2,3,1}), the CG PUSCH transmission occasions that are used to start the initial transmission are determined according to the above RV patterns.

### (1) The RV Pattern is {0,0,0,0}

For multi-TRP based CG PUSCH repetition type A, it is proposed that for all the transmission occasions associated with the first UL beam (i.e. the first TRP), if the first RV sequence to be applied to the transmission occasions associated with the first UL beam is the RV pattern of {0,0,0,0}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the first starting from RV0 switch is set to ‘on’, the initial transmission of a transport block may start at any of transmission occasions of the repetitions associated with the first UL beam (i.e. the first TRP) except the last transmission occasion associated with the first UL beam when the number of the repetitions (e.g. the higher layer parameter of repK) is at least 8. For all the transmission occasions associated with the second UL beam (i.e. the second TRP), if the second RV sequence to be applied to the transmission occasions associated with the second UL beam is the RV pattern of {0,0,0,0}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the second starting from RV0 switch is set to ‘on’, the initial transmission of a transport block may start at any of transmission occasions of the repetitions associated with the second UL beam (i.e. the second TRP) except the last transmission occasion associated with the second UL beam when the number of the repetitions (e.g. the higher layer parameter of repK) is at least 8.

For multi-TRP based CG PUSCH repetition type B, it is proposed that for all the transmission occasions associated with the first UL beam (i.e. the first TRP), if the first RV sequence to be applied to the transmission occasions associated with the first UL beam is the RV pattern of {0,0,0,0}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the first starting from RV0 switch is set to ‘on’, the initial transmission of a transport block may start at any of the transmission occasions of the actual repetitions associated with the first UL beam (i.e. the first TRP) except the actual repetitions within the last nominal repetition associated with the first UL beam when the number of the repetitions (e.g. the higher layer parameter of repK) is at least 8. For all the transmission occasions associated with the second UL beam (i.e. the second TRP), if the second RV sequence to be applied to the transmission occasions associated with the second UL beam is the RV pattern of {0,0,0,0}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the second starting from RV0 switch is set to ‘on’, the initial transmission of a transport block may start at any of the transmission occasions of the actual repetitions associated with the second UL beam (i.e. the second TRP) except the actual repetitions within the last nominal repetition associated with the second UL beam when the number of the repetitions (e.g. the higher layer parameter of repK) is at least 8. Here, for the CG PUSCH repetition type B, one CG PUSCH transmission occasion is associated to one actual repetition.

### (2) The RV Patterns are {0,3,0,3} and {0,2,3,1}

For multi-TRP based CG PUSCH repetition type A, it is proposed that for all the transmission occasions associated with the first UL beam (i.e. the first TRP), if the first RV sequence to be applied to the transmission occasions associated with the first UL beam is the RV pattern of {0,3,0,3}/{0,2,3,1}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the first starting from RV0 switch is set to ‘on’, the initial transmission of a transport block may start at any of transmission occasions of the repetitions that are associated with RV=0 and are associated with the first UL beam (i.e. the first TRP). For all the transmission occasions associated with the second UL beam (i.e. the second TRP), if the second RV sequence to be applied to the transmission occasions associated with the second UL beam is the RV pattern of {0,3,0,3}/{0,2,3,1}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the second starting from RV0 switch is set to ‘on’, the initial transmission of a transport block may start at any of transmission occasions of the repetitions that are associated with RV=0 and are associated with the second UL beam (i.e. the second TRP).

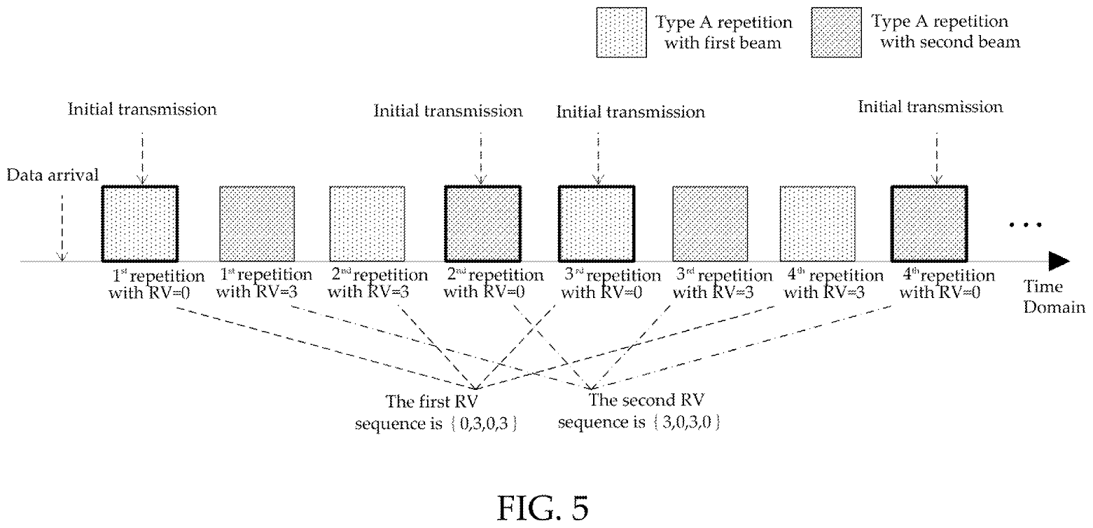

For the cases of CG PUSCH repetition type A with cyclic beam mapping pattern, as is shown in FIG. 5, when the feature of starting from RV0 for two sets of CG PUSCH transmission occasions associated with two UL beams is enabled, regarding the first UL beam, the initial transmission of a transport block may start at the first and third repetitions; while for the second UL beam, the initial transmission may start at the second and the fourth repetitions.

For multi-TRP based CG PUSCH repetition type B, it is proposed that for all the transmission occasions associated with the first UL beam (i.e. the first TRP), if the first RV sequence to be applied to the transmission occasions associated with the first UL beam is the RV pattern of {0,3,0,3}/{0,2,3,1}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the first starting from RV0 switch is set to ‘on’, the initial transmission of a transport block may start at any of transmission occasions of the actual repetitions that are associated with RV=0 and are associated with the first UL beam (i.e. the first TRP). For all the transmission occasions associated with the second UL beam (i.e. the second TRP), if the second RV sequence to be applied to the transmission occasions associated with the second UL beam is the RV pattern of {0,3,0,3}/{0,2,3,1}, and if only one starting from RV0 switch (e.g. startingFromRV0-r16) is configured in the configured grant configuration (e.g. ConfiguredGrantConfig) and the starting from RV0 switch is set to ‘on’, or two starting from RV0 switches (e.g. startingFromRV0-r16) are configured in the configured grant configuration (e.g. ConfiguredGrantConfig) and the second starting from RV0 switch is set to ‘on’, the initial transmission of a transport block may start at any of transmission occasions of the actual repetitions that are associated with RV=0 and are associated with the second UL beam (i.e. the second TRP). Here, for the CG PUSCH repetition type B, one CG PUSCH transmission occasion is associated to one actual repetition.

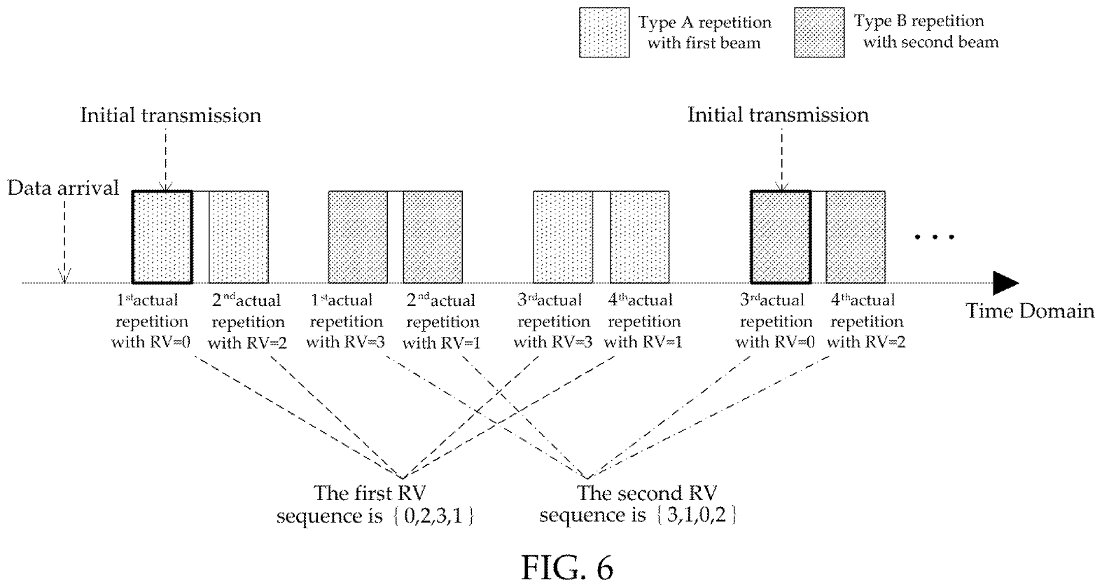

For the cases of CG PUSCH repetition type B with cyclic beam mapping pattern, as is shown in FIG. 6, when the feature of starting from RV0 for two sets of CG PUSCH transmission occasions associated with two UL beams is enabled, the initial transmission of a transport block may start at the first actual repetition associated with the first UL beam and the third actual repetition associated with the second UL beam.

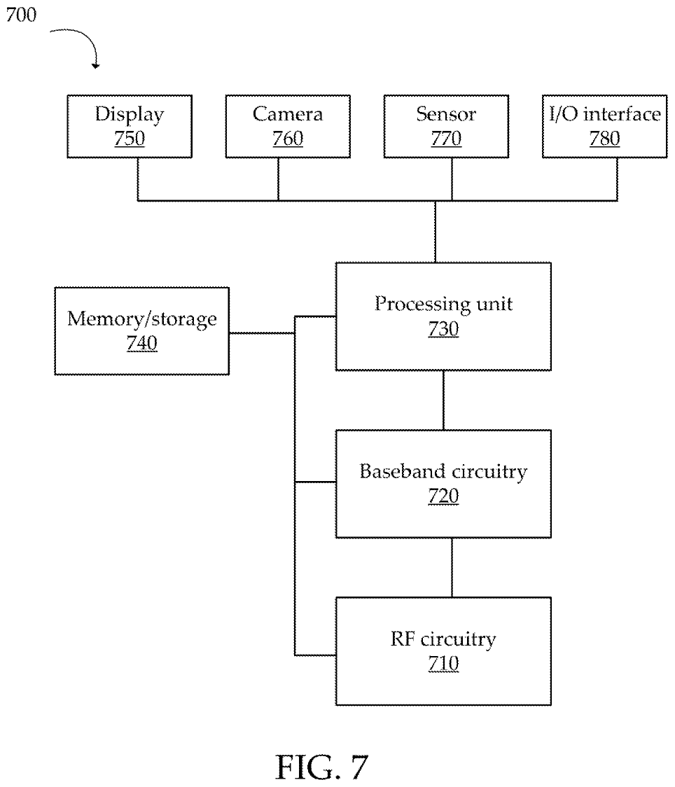

FIG. 7 is a block diagram of an example system 700 for wireless communication according to an embodiment of the present disclosure. Embodiments described herein may be implemented into the system using any suitably configured hardware and/or software. FIG. 7 illustrates the system 700 including a radio frequency (RF) circuitry 710, a baseband circuitry 720, a processing unit 730, a memory/storage 740, a display 750, a camera 760, a sensor 770, and an input/output (I/O) interface 780, coupled with each other as illustrated.

The processing unit 730 may include a circuitry, such as, but not limited to, one or more single-core or multi-core processors. The processors may include any combinations of general-purpose processors and dedicated processors, such as graphics processors and application processors. The processors may be coupled with the memory/storage and configured to execute instructions stored in the memory/storage to enable various applications and/or operating systems running on the system.

The baseband circuitry 720 may include a circuitry, such as, but not limited to, one or more single-core or multi-core processors. The processors may include a baseband processor. The baseband circuitry may handle various radio control functions that enable communication with one or more radio networks via the RF circuitry. The radio control functions may include, but are not limited to, signal modulation, encoding, decoding, radio frequency shifting, etc. In some embodiments, the baseband circuitry may provide for communication compatible with one or more radio technologies. For example, in some embodiments, the baseband circuitry may support communication with 5G NR, LTE, an evolved universal terrestrial radio access network (EUTRAN) and/or other wireless metropolitan area networks (WMAN), a wireless local area network (WLAN), a wireless personal area network (WPAN). Embodiments in which the baseband circuitry is configured to support radio communications of more than one wireless protocol may be referred to as multi-mode baseband circuitry. In various embodiments, the baseband circuitry 720 may include circuitry to operate with signals that are not strictly considered as being in a baseband frequency. For example, in some embodiments, baseband circuitry may include circuitry to operate with signals having an intermediate frequency, which is between a baseband frequency and a radio frequency.

The RF circuitry 710 may enable communication with wireless networks using modulated electromagnetic radiation through a non-solid medium. In various embodiments, the RF circuitry may include switches, filters, amplifiers, etc. to facilitate the communication with the wireless network. In various embodiments, the RF circuitry 710 may include circuitry to operate with signals that are not strictly considered as being in a radio frequency. For example, in some embodiments, RF circuitry may include circuitry to operate with signals having an intermediate frequency, which is between a baseband frequency and a radio frequency.

In various embodiments, the transmitter circuitry, control circuitry, or receiver circuitry discussed above with respect to the UE, eNB, gNB or TRP may be embodied in whole or in part in one or more of the RF circuitries, the baseband circuitry, and/or the processing unit. As used herein, “circuitry” may refer to, be part of, or include an Application Specific Integrated Circuit (ASIC), an electronic circuit, a processor (shared, dedicated, or group), and/or a memory (shared, dedicated, or group) that execute one or more software or firmware programs, a combinational logic circuit, and/or other suitable hardware components that provide the described functionality. In some embodiments, the electronic device circuitry may be implemented in, or functions associated with the circuitry may be implemented by, one or more software or firmware modules. In some embodiments, some or all of the constituent components of the baseband circuitry, the processing unit, and/or the memory/storage may be implemented together on a system on a chip (SOC).

The memory/storage 740 may be used to load and store data and/or instructions, for example, for system. The memory/storage for one embodiment may include any combination of suitable volatile memory, such as dynamic random access memory (DRAM)), and/or non-volatile memory, such as flash memory. In various embodiments, the I/O interface 780 may include one or more user interfaces designed to enable user interaction with the system and/or peripheral component interfaces designed to enable peripheral component interaction with the system. User interfaces may include, but are not limited to a physical keyboard or keypad, a touchpad, a speaker, a microphone, etc. Peripheral component interfaces may include, but are not limited to, a non-volatile memory port, a universal serial bus (USB) port, an audio jack, and a power supply interface.

In various embodiments, the sensor 770 may include one or more sensing devices to determine environmental conditions and/or location information related to the system. In some embodiments, the sensors may include, but are not limited to, a gyro sensor, an accelerometer, a proximity sensor, an ambient light sensor, and a positioning unit. The positioning unit may also be part of, or interact with, the baseband circuitry and/or RF circuitry to communicate with components of a positioning network, e.g., a global positioning system (GPS) satellite. In various embodiments, the display 750 may include a display, such as a liquid crystal display and a touch screen display. In various embodiments, the system 700 may be a mobile computing device such as, but not limited to, a laptop computing device, a tablet computing device, a netbook, an ultrabook, a smartphone, etc. In various embodiments, system may have more or less components, and/or different architectures. Where appropriate, methods described herein may be implemented as a computer program. The computer program may be stored on a storage medium, such as a non-transitory storage medium.

The embodiment of the present disclosure is a combination of techniques/processes that can be adopted in 3GPP specification to create an end product.

A person having ordinary skill in the art understands that each of the units, algorithm, and steps described and disclosed in the embodiments of the present disclosure are realized using electronic hardware or combinations of software for computers and electronic hardware. Whether the functions run in hardware or software depends on the condition of application and design requirement for a technical plan. A person having ordinary skill in the art can use different ways to realize the function for each specific application while such realizations should not go beyond the scope of the present disclosure. It is understood by a person having ordinary skill in the art that he/she can refer to the working processes of the system, device, and unit in the above-mentioned embodiment since the working processes of the above-mentioned system, device, and unit are basically the same. For easy description and simplicity, these working processes will not be detailed.

It is understood that the disclosed system, device, and method in the embodiments of the present disclosure can be realized with other ways. The above-mentioned embodiments are exemplary only. The division of the units is merely based on logical functions while other divisions exist in realization. It is possible that a plurality of units or components are combined or integrated in another system. It is also possible that some characteristics are omitted or skipped. On the other hand, the displayed or discussed mutual coupling, direct coupling, or communicative coupling operate through some ports, devices, or units whether indirectly or communicatively by ways of electrical, mechanical, or other kinds of forms.

The units as separating components for explanation are or are not physically separated. The units for display are or are not physical units, that is, located in one place or distributed on a plurality of network units. Some or all of the units are used according to the purposes of the embodiments. Moreover, each of the functional units in each of the embodiments can be integrated in one processing unit, physically independent, or integrated in one processing unit with two or more than two units.

If the software function unit is realized and used and sold as a product, it can be stored in a readable storage medium in a computer. Based on this understanding, the technical plan proposed by the present disclosure can be essentially or partially realized as the form of a software product. Or, one part of the technical plan beneficial to the conventional technology can be realized as the form of a software product. The software product in the computer is stored in a storage medium, including a plurality of commands for a computational device (such as a personal computer, a server, or a network device) to run all or some of the steps disclosed by the embodiments of the present disclosure. The storage medium includes a USB disk, a mobile hard disk, a read-only memory (ROM), a random access memory (RAM), a floppy disk, or other kinds of media capable of storing program codes.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A transmitter, configured to communicate in a communication system, the transmitter comprising:
one or more interfaces configured to communicate with multiple transmission-reception points (multi-TRPs) within the communication system; and
a circuitry configured to:
receive or transmit an indication of a support of single-TRP based configured grant (CG) physical uplink shared channel (PUSCH) repetition or multi-TRP based CG PUSCH repetition.

2. The transmitter according to claim 1, wherein the indication is carried out by a parameter of configured grant configuration.

3. (canceled)

4. The transmitter according to claim 2, wherein the indication is carried out by a field with one bit in the parameter of the configured grant configuration.

5-10. (canceled)

11. The transmitter according to claim 2, wherein the indication is represented by a field with more than one bits in the parameter of the configured grant configuration.

12. (canceled)

13. The transmitter according to claim 1, wherein the indication is carried out by downlink control information (DCI) scheduling CG type 2 PUSCH transmission.

14. The transmitter according to claim 13, wherein the indication is carried out by a field with one bit in the DCI.

15-16. (canceled)

17. The transmitter according to claim 13, wherein the indication is carried out by a field with more than one bit in the DCI.

18-20. (canceled)

21. A transmitter, configured to communicate in a communication system, the transmitter comprising:
one or more interfaces configured to communicate with multiple transmission-reception points (multi-TRPs) within the communication system; and
a circuitry configured to:
receive or transmit an indication to enable, responsive to that multi-TRP based configured grant (CG) physical uplink shared channel (PUSCH) repetition is configured, one of a plurality of beam mapping patterns by a field in a parameter of configured grant configuration.

22. The transmitter according to claim 21, wherein one of the plurality of beam mapping patterns includes a cyclical mapping pattern, a sequential mapping pattern or a half-half mapping pattern, and wherein responsive to that the cyclical mapping pattern is enabled, a first UL beam associated with a first TRP and a second UL beam associated with a second TRP are applied to a first CG PUSCH repetition and a second CG PUSCH repetition, respectively, and the same beam mapping pattern continues to remaining CG PUSCH repetitions; responsive to that the sequential mapping pattern is enabled, the first UL beam associated with the first TRP is applied to the first CG PUSCH repetition and the second CG PUSCH repetition, and the second UL beam associated with the second TRP is applied to a third CG PUSCH repetition and a fourth CG PUSCH repetition, and the same beam mapping pattern continues to remaining CG PUSCH repetitions; and responsive to that the half-half mapping pattern is enabled, the first UL beam associated with the first TRP is applied to a first half of CG PUSCH repetitions, and the second UL beam associated with the second TRP is applied to a second half of the CG PUSCH repetitions.

23. The transmitter according to claim 21, wherein responsive to that CG PUSCH repetition type B is configured, one CG PUSCH transmission occasion is associated to one nominal repetition.

24. The transmitter according to claim 21, wherein responsive to that CG PUSCH repetition type B is configured, and further responsive to that two actual repetitions are associated with different UL beams, a switching gap exists between the two consecutive actual repetitions.

25. The transmitter according to claim 24, wherein the switching gap is predefined depending on whether the UL beams are from the same or different panels.

26. The transmitter according to claim 24, wherein the switching gap is configured by radio resource control (RRC), MAC control element (MAC CE) or downlink control information (DCI).

27. A transmitter, configured to communicate in a communication system, the transmitter comprising:
one or more interfaces configured to communicate with multiple transmission-reception points (multi-TRPs) within the communication system; and
a circuitry configured to:
receive or transmit an indication to indicate, by a parameter of configured grant configuration, a redundancy version (RV) offset and a configured RV sequence for multi-TRP based configured grant (CG) physical uplink shared channel (PUSCH) repetition, wherein the configured RV sequence is configured to determine a first RV sequence applied to transmission occasions associated to a first TRP, and the RV offset is configured to determine a second RV sequence applied to transmission occasions associated to a second TRP.

28. The transmitter according to claim 27, wherein the RV offset is an offset from the configured RV sequence.

29. The transmitter according to claim 27, wherein the first RV sequence applied to the transmission occasions associated to the first TRP is configured by the configured RV sequence in the configured grant configuration, and the second RV sequence applied to the transmission occasions associated to the second TRP is determined by the RV offset from the first RV sequence.

30-48. (canceled)

49. The transmitter according to claim 1, wherein the indication in higher layer parameters is used to indicate one of the single-TRP based CG PUSCH repetition with a first TRP, the single-TRP based CG PUSCH repetition with a second TRP and the multi-TRP based CG PUSCH repetition.

50. The transmitter according to claim 21, wherein one of the plurality of beam mapping patterns includes a cyclical mapping pattern or a sequential mapping pattern.

51. The transmitter according to claim 50, wherein responsive to that the cyclical mapping pattern is enabled, a first UL beam associated with a first TRP and a second UL beam associated with a second TRP are applied to a first CG PUSCH repetition and a second CG PUSCH repetition, respectively, and the same beam mapping pattern continues to remaining CG PUSCH repetitions.

52. The transmitter according to claim 50, wherein responsive to that the sequential mapping pattern is enabled, the first UL beam associated with the first TRP is applied to the first CG PUSCH repetition and the second CG PUSCH repetition, and the second UL beam associated with the second TRP is applied to a third CG PUSCH repetition and a fourth CG PUSCH repetition, and the same beam mapping pattern continues to remaining CG PUSCH repetitions.
